(19) United States
(12) Patent Application Publication
(10) Pub. No.: US 2012/0198436 A1
(43) Pub. Date: Aug. 2, 2012

(54) Compatible Operating System

(76) Inventors: Lee A. Preimesberger, Houston, TX (US); Eric Ramirez, Houston, TX (US); Nguyettrang T. Truong, Houston, TX (US)

(21) Appl. No.: 13/014,996

(22) Filed: Jan. 27, 2011

(51) Int. Cl. G06F 9/445

(52) U.S. Cl. 717/174

(57) ABSTRACT

A device to perform an inventory of components for the device in response to detecting at least one operating system on a storage device coupled to the device, identify at least one compatible operating system from the storage device based on the inventory of components, and generate a user interface on a display device to list at least one of the compatible operating systems.

### BACKGROUND

When installing an operating system, a user can load media into a device. The device can identify whether one or more operating systems are available on the media. The user can then proceed to select one or more of the operating systems to install onto the device without knowing whether the selected operating system is supported by the device. Once an operating system has been selected, the device can proceed to install the selected operating system from the media. If any incompatibilities or errors are detected during the installation, the device can display one or more error messages during the installation. Additionally, the device can create a summary of the errors at the end of the installation or the device can halt installation of the operating system.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the disclosed embodiments.

FIG. 1 illustrates a device coupled to one or more storage devices with at least one operating system according to an embodiment.

FIG. 2 illustrates a device coupled one or more storage devices and one or more components according to an embodiment.

FIG. 3 illustrates a block diagram of an embedded application performing an inventory of components and identifying a compatible operating system according to an embodiment.

FIG. 4 illustrates a block diagram of an embedded application generating a user interface to list compatible operating systems on a storage device according to an embodiment.

FIG. 5A illustrates a block diagram of an embedded application installing a compatible operating system in response to a user selecting an operating system to install according to an embodiment.

FIG. 5B illustrates a block diagram of an embedded application generating a user interface in response to a user selecting an operating system family according to an embodiment.

FIG. 6 is a flow chart illustrating a method for identifying a compatible operating system according to an embodiment.

FIG. 7 is a flow chart illustrating a method for identifying a compatible operating system according to another embodiment.

### DETAILED DESCRIPTION

By detecting one or more operating systems on storage devices coupled to a device, the device can proceed to perform an inventory of components for the device. Based on the information collected from the inventory of components, the device can efficiently and accurately identify one or more compatible operating systems on the coupled storage devices. Additionally, by rendering a user interface on a display device to list one or more of the compatible operating systems, a user friendly experience can be created for a user of the device by automatically displaying compatible operating systems which can be installed onto the device, while excluding incompatible operating systems from the selection. As a result, user error can be reduced, time can be saved, and device stability can be increased by reducing opportunities for an incompatible operating system to be installed onto the device.

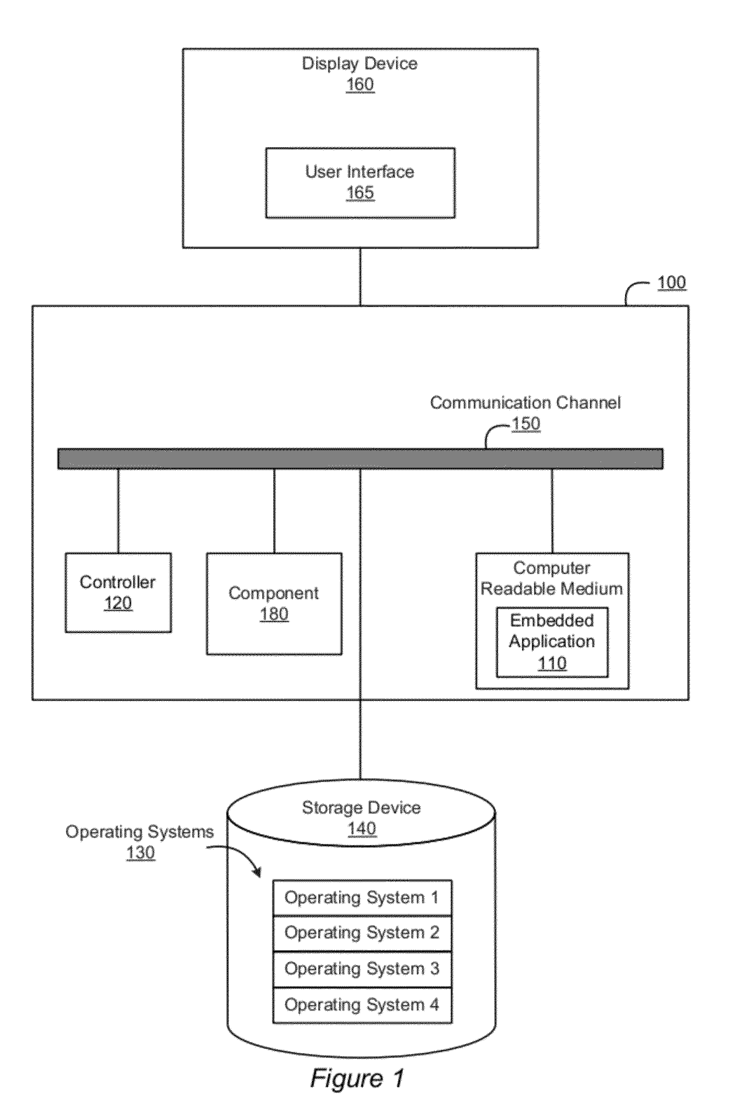

FIG. 1 illustrates a device 100 coupled to a storage device 140 with one or more operating systems 130 according to an embodiment. In one embodiment, the device 100 is or includes a desktop, a laptop, a notebook, a tablet, a netbook, an all-in-one system, a server, and/or the like. In another embodiment, the device 100 is a cellular device, a PDA, an entertainment system and/or any additional device which can be coupled to a storage device 140 with one or more operating systems 130.

As illustrated in FIG. 1, the device 100 includes and/or is coupled to a controller 120, one or more components 180, an embedded application 110 accessible from computer readable memory, and a communication channel 150. The device 100 can be coupled to a display device 160 and one or more storage device 140. Additionally, as illustrated in FIG. 1, one or more of the storage devices 140 can include at least one operating system 130. In other embodiments, the device 100 includes additional components and/or is coupled to additional components in addition to and/or in lieu of those noted above and illustrated in FIG. 1.

As noted above, the device 100 includes a controller 120. The controller 120 can send data and/or instructions to the components of the device 100 or components 180 coupled the device 100, such as the embedded application 110, the display device 160, and/or one or more storage devices 140 using the communication channel 150. Additionally, the controller 120 can receive data and/or instructions from components of the device 100 or components 180 coupled to the device 100, such as the embedded application 110, the display device 160, and/or one or more storage devices 140 using the communication channel 150.

The embedded application 110 is an application which can be utilized in conjunction with the controller 120 to identity one or more compatible operating systems 130 which can be loaded and/or installed onto the device 100. For the purposes of this application, a compatible operating system 130 can be an operating system which supports and/or includes component drivers for each component 180 coupled to the device 100 or included in the device 100.

A component 180 can be a hardware device or component which can be included in and/or coupled to the device 100 through a wired or wireless connection. In one embodiment, a component 180 can be or include a display device, a video component, an audio component, an input device, and/or a network interface component. A component driver 170 can include software and/or firmware utilized by the controller 120, the embedded application 110, and/or a compatible operating system to communicate with and/or control a component of the device 100. In one embodiment, a component driver can be or include a video component driver, an audio component driver, a network interface component driver, a display device component driver, and/or an input device component driver.

When identifying at least one compatible operating system 130, the embedded application 110 and/or the controller 120 can perform an inventory of components 180 for the device 100 in response to detecting at least one operating system 130 on a storage device 140 couple to the device 100. In one embodiment, performing the inventory of components 180 includes the controller 120 and/or the embedded application 110 accessing each component 180 included in and/or coupled to the device 100 and reading identification numbers for each of the components 180. For the purposes of this application, an identification number can include a sequence of numbers, letters, characters, and/or symbols which is unique to a corresponding component 180 of the device 100. Utilizing an identification number, the controller 120 and/or the embedded application 110 can accurately identify a corresponding component 180 coupled to the device 100. Once the inventory of components 180 is complete, the controller 120 and/or the embedded application 110 can proceed to identify at least one compatible operating system 130 compatible from the storage device 140 based on results from the inventory of components 180.

If one or more operating compatible systems 130 are detected on one or more of the storage devices 140, the controller 120 and/or the embedded application 110 can proceed to generate a user interface 165 on the display device 160 to list at least one of the compatible operating systems 130. The display device 160 can be an analog or a digital device configured by the controller 120 and/or the embedded application to render, display, and/or project the user interface 170 as one or more pictures and/or moving videos. The user interface 170 can list at least one of the compatible operating systems 130 as text, an object, menu, and/or image for a user of the device 200 to select.

The embedded application 110 can be a firmware of the controller 120 and/or the device 100. In one embodiment, the embedded application 110 can be a Basic Input Output System of the device 100. In another embodiment, the embedded application 110 can be an embedded operating system stored on the device 100 within a read only memory or on a computer readable medium accessible by the controller 120 and/or the device 100.

Additionally, in one embodiment, the computer readable medium is included in the device 100 or the computer readable medium is coupled to the device 100. In other embodiments, the computer readable medium is not included in the device 100, but is accessible to the device 100 utilizing a network interface component included in the device 100. The network interface component can be a wired or wireless network interface card. In other embodiments, the computer readable medium can be configured to couple to one or more ports or interfaces on the device 100 wirelessly or through a wired connection.

In a further embodiment, the embedded application 110 is stored and/or accessed through a server coupled through a local area network or a wide area network. The embedded application 110 communicates with devices and/or components coupled to the device 100 physically or wirelessly through a communication bus 150 included in or attached to the device 100. In one embodiment the communication bus 150 is a memory bus. In other embodiments, the communication bus 150 is a data bus.

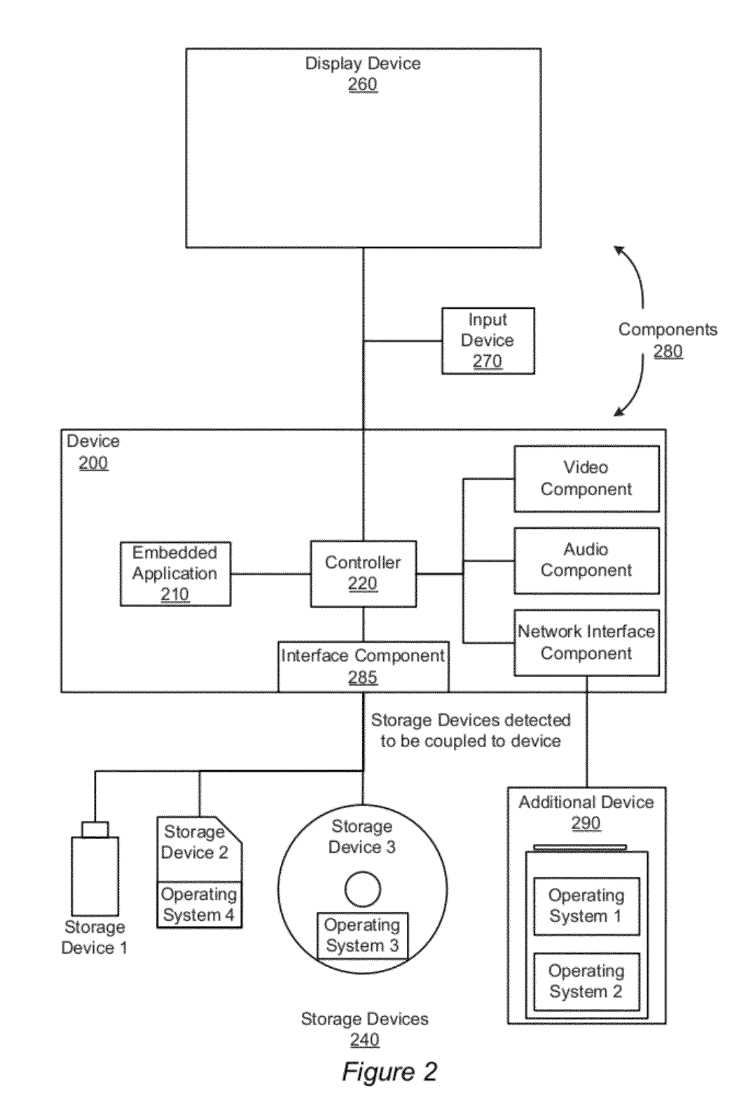

FIG. 2 illustrates a device 200 coupled to one or more storage devices 240 and one or more components 280 according to an embodiment. A storage device 240 can be a device or component configured to store data and/or information, such as an operating system, for the device 200 to access. In one embodiment, a storage device 240 can be or include an internal hard drive, an external hard drive, a network storage device, a compact disc, a digital versatile disc, a Blu-ray disc, a universal serial bus device, a serial device, a secure digital device, a compact flash device, an extreme digital device, and/or any additional device configured to store data and/or information.

One or more storage device 240 can be included in the device 200 and can be coupled to the controller 220 and/or the embedded application 210 through a communication channel of the device 200. In another embodiment, one or more storage device 240 can be externally coupled to the device 200 or a storage device 240 can be stored on an additional device 290 accessible to the device 200 through one or more interface components 285. An interface component 285 is a hardware component of the device 200 configured to couple and interface a storage device 240 with the controller 220 and/or the embedded application 210 through a wired or wireless connection.

One or more of the interface components 285 can be or include a universal serial bus port, a serial device port, a compact flash port, an extreme digital card port, a secure digital card port, a serial advanced technology attachment port, an external serial advanced technology attachment port, a peripheral component interconnect express port, an integrated driver electronics port, a network interface component, a Bluetooth component, an infrared component, and/or any additional port configured to couple and interface a storage device 240 with the controller 220 and/or the embedded application 210.

As noted above, the controller 220 and/or the embedded application 210 can detect one or more storage devices 240 for at least one operating system. In one embodiment, the controller 220 and/or the embedded application 210 detect a storage device 240 for at least one operating system in response to the device 200 entering a boot phase. The device 200 can enter a boot phase if one or more components 280 of the device 200 power on from a power off state.

When detecting one or more storage devices 240 for at least one operating system, the controller 220 and/or the embedded application 210 can access the communication channel, the interface component 285, and/or the network interface to detect any storage devices 240 coupled to the device 200. If any storage devices 240 are detected, the controller 220 and/or the embedded application 210 can access the information and/or data of the coupled storage devices 220 to determine if one or more operating systems are present.

As illustrated in FIG. 2, the controller 220 and/or the embedded application 210 have detected storage device 1, storage device 2, storage device 3, and additional device 290 to be coupled to the interface component 290 and the network interface component. Additionally, the controller 220 and/or the embedded application 210 have detected storage device 1, storage device 2, storage device 3, and the additional device to include operating system 1, operating system 2, operating system 3, and operating system 4 respectively.

In response to detecting one or more operating systems on a storage device, the controller 220 and/or the embedded application 210 can proceed to perform an inventory of components 280 for the device 200. As noted above, a component 280 can be a hardware device or component which can be included in and/or coupled to the device 100 through a wired or wireless connection. As shown in the present embodiment, one or more of the components 280 can be included in the device 200. In another embodiment, one or more of the components 280 can be integrated as part of the device 200. In other embodiments, one or more of the components 280 can be externally coupled to the device 200.

One or more of the components 280 can be or include a display device 260, an input device, a video component, an audio component, and/or a network interface component. In other embodiments, one or more of the components 280 can be or include any additional hardware component or device coupled to the device 200 through a wired or wireless connection in addition to and/or in lieu of those noted above and illustrated in FIG. 2.

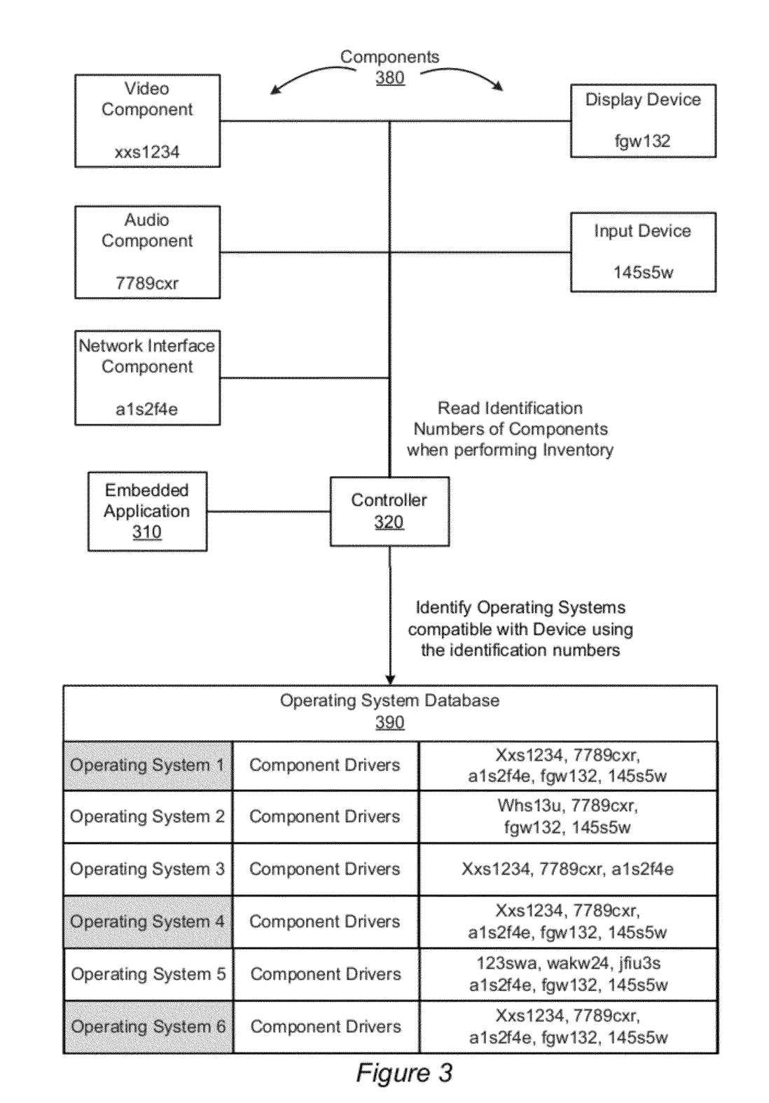

FIG. 3 illustrates a block diagram of an embedded application 310 performing an inventory of components 380 and identifying a compatible operating system according to an embodiment. As noted above, performing the inventory of components 380 includes the controller 320 and/or the embedded application 310 accessing components 380 included in and/or coupled to the device 300 and reading identification numbers of each component 380.

As shown in FIG. 3, an identification number can include a sequence of numbers, letters, characters, and/or symbols which is unique to corresponding components 380 of the device 300. In one embodiment, an identification number can be stored on a printed circuit board of a component 380. In another embodiment, the identification number can be stored in a file, metadata, and/or a header of a component 380. In other embodiment, an identification number can include additional data and/or information and can be stored on additional locations in addition to and/or in lieu of those noted above and illustrated in FIG. 3.

The controller 320 and/or the embedded application 310 can access the video component, the display device, the audio component, the input device, and/or the network interface component and proceed to read their identifications numbers. As shown in the present embodiment, the controller 320 and/or the embedded application 310 determine that a corresponding identification number for the video component is xxs1234, a corresponding identification number for the display device is fgw132, a corresponding identification number for the audio component is 7789cxr, a corresponding identification number for the input device is 145s5w, and a corresponding identification number for the network interface component is a1s2f4e.

In response to reading the identification numbers for each of the components 380, the controller 320 and/or the embedded application 310 can attempt to identify a compatible operating system based on the inventory of components 380. In one embodiment, when identifying a compatible operating system, the controller 320 and/or the embedded application 310 can access entries from an operating system database 390 and determine whether any of the entries include the identification numbers of the components 380.

The operating system database 390 can include one or more entries, each corresponding to a different operating system. The operating system database 390 can be locally stored on the device 300 or the operating system database 390 can be remotely accessed from another location through the network interface component. As illustrated in FIG. 3, each of the entries in the operating system database 390 list identification numbers of components 380 supported by a corresponding operating system. If an identification number of a component 380 is included in an entry of a corresponding operating system, the corresponding operating system will be determined to include or support component drivers for the corresponding component 380.

As shown in the present embodiment, the controller 320 and/or the embedded application 310 access each of the entries in the operating system database 390 and determine whether any of the entries include identification numbers: xxs1234, fgw132, 7789cxr, 145s5w, and a1s2f4e. The controller 320 and/or the embedded application 310 determine that the entries for Operating System 1, Operating System 4, and Operating System 6 include matching identification numbers.

As a result, the controller 320 and/or the embedded application 310 determine that Operating System 1, Operating System 4, and Operating System 6 include or support component drivers for the components 380 of the device 300. As noted above, a component driver can include software and/or firmware utilized by the controller 320, the embedded application 410, and/or a compatible operating system to communicate with and/or control a component 380 of the device 300. In one embodiment, as shown in FIG. 3, a component driver can be stored on the operating system database 390. In another embodiment, a component driver can be stored on a storage device which includes the compatible operating system. In other embodiments, a component driver can be retrieved from another location using the network interface component.

Because Operating System 1, Operating System 4, and Operating System 6 support or included component drivers for the components 380 of the device 300, the controller 320 and/or the embedded application 310 identify Operating System 1, Operating System 4, and Operating System 6 to be compatible operating systems which can be installed onto the device 300.

In one embodiment, one or more entries of the operating system database 390 can be updated to include additional identification numbers and/or additional component drivers. In another embodiment, the operating system database 390 can be updated to include additional entries of new operating systems. The operating system database 390 and one or more of its entries can be updated locally by the controller 320 and/or the embedded application 310. In another embodiment, the operating system database 390 and one or more of its entries can be updated through the network interface component.

By updating the operating system database 390, support for new operating systems can be added to the database and existing operating systems which are later determined to be compatible with the components 380 of the device can have their entries updated to include the identification numbers of the components 380.

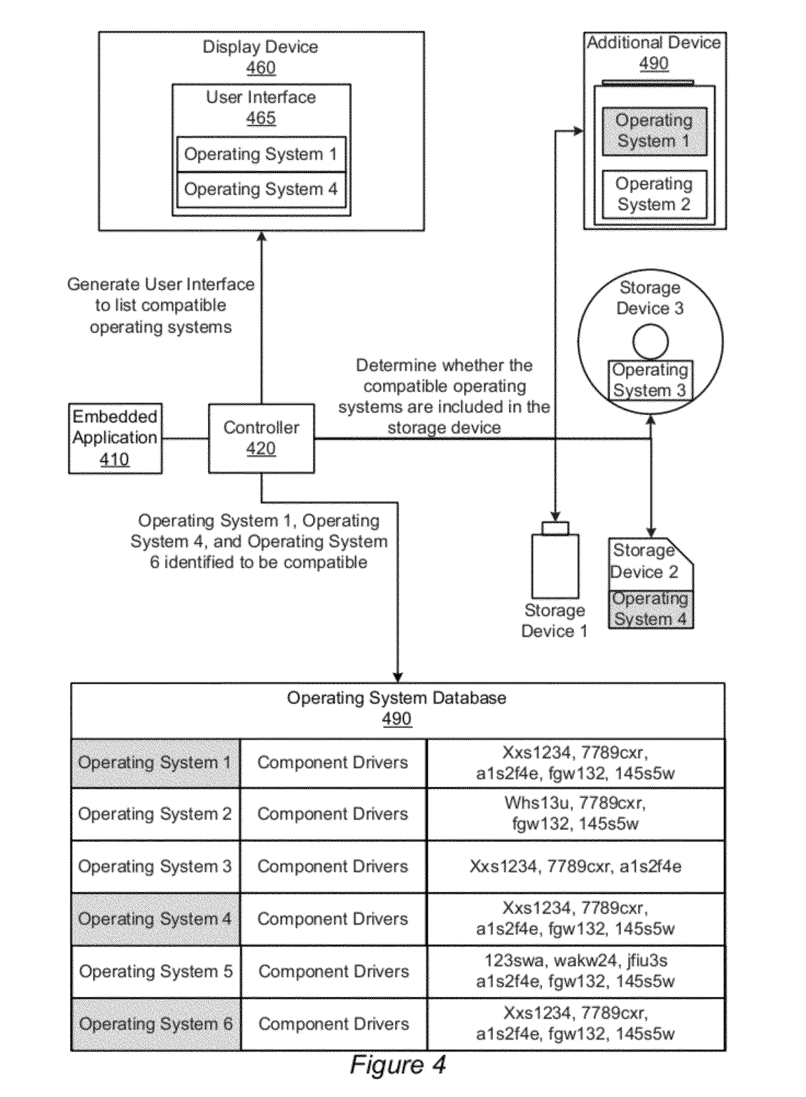

FIG. 4 illustrates a block diagram of an embedded application 410 generating a user interface 470 to list compatible operating systems on a storage device according to an embodiment. As shown in the present embodiment, the controller 420 and/or the embedded application 410 access the operating system database 490 and identify Operating System 1, Operating System 4, and Operating System 6 to be compatible operating systems.

In response to identifying one or more compatible operating systems, the controller 420 and/or the embedded application 410 proceed to determine whether one or more of the compatible operating systems are included in a coupled storage device. As shown in FIG. 4, the controller 420 and/or the embedded application 410 access storage device 1, storage device 2, storage device 3, and the additional device 490 to determine whether the data and/or information included in the corresponding storage devices include one or more of the compatible operating systems.

The controller 420 and/or the embedded application 410 determine that storage device 1 does not include any of the compatible operating systems. The controller 420 and/or the embedded application 410 go on to determine that compatible operating system 1 is stored on the additional device 490 and compatible operating system 4 is included in storage device 2. In response to detecting one or more of the compatible operating systems on one or more coupled storage devices, the controller 420 and/or the embedded application 410 proceed to generate a user interface 465 on a display device 460 to list the compatible operating systems.

The display device 460 can be an analog or a digital device configured to render, display, and/or project a user interface as one or more text, pictures, and/or moving videos. In one embodiment, the display device 460 can be a LCD (liquid crystal display), a LED (light emitting diode) display, a CRT (cathode ray tube) display, a plasma display, a projector and/or any additional device configured to render a user interface 465. As noted above, the user interface 470 can be rendered to include text, images, and/or videos. As shown in the present embodiment, the controller 420 and/or the embedded application 410 render the user interface 465 to list compatible operating system 1 and compatible operating system 4.

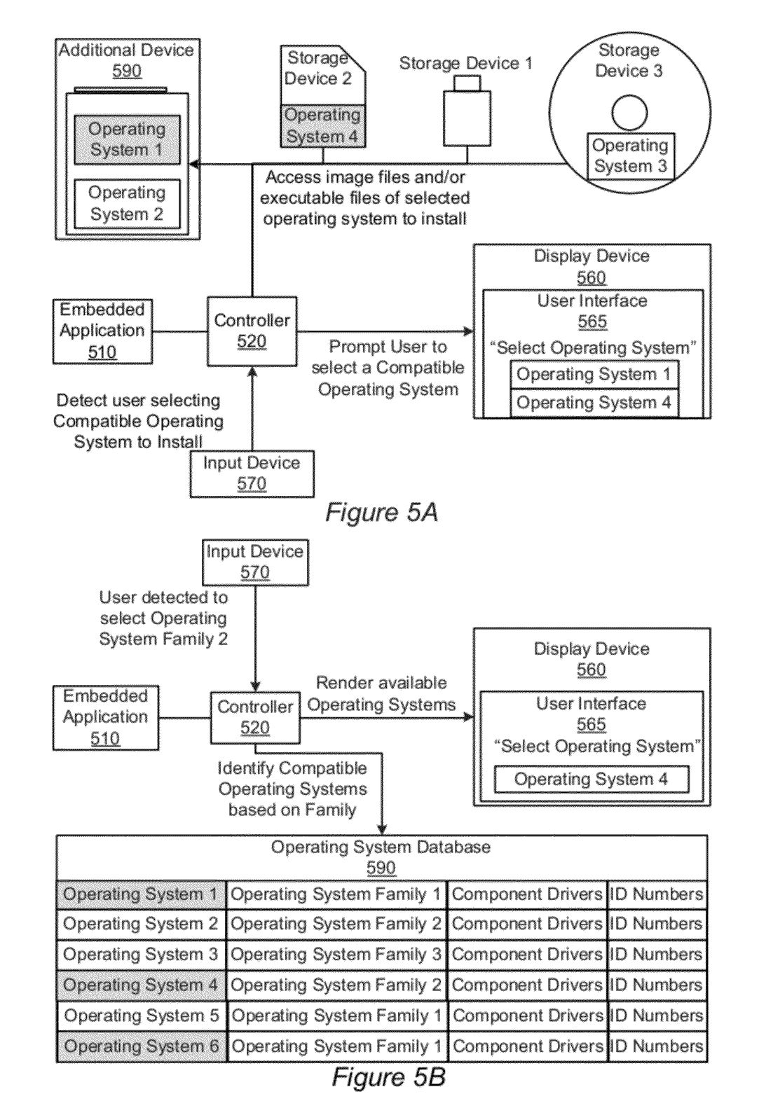

FIG. 5A illustrates a block diagram of an embedded application 510 installing a compatible operating system in response to a user selecting an operating system to install according to an embodiment. As shown in FIG. 5A, a display device 560 can render a user interface 570 to list compatible operating system 1 and compatible operating system 4. In one embodiment, the controller 520 and/or the embedded application 510 can additionally render the user interface 570 to display one or more messages and/or prompts to a user of the device. As shown in the present embodiment, one or more messages can prompt the user to select a compatible operating system to install.

In response to listing one or more of the compatible operating systems, an input device 570 can detect a user selecting one or more compatible operating systems to install onto the device. The input device 570 is a hardware component of the device configured to detect a user navigating the user interface 565 and detect the user selecting one or more compatible operating systems to install. In one embodiment, the input device 570 can be a keyboard, a mouse, a touch device, an image capture device, a microphone, and/or any additional device configured to detect a user selecting a compatible operating system to install.

If the input device 570 detects the user selecting one or more compatible operating systems to install, the controller 520 and/or the embedded application 510 can proceed to install a selected operating system onto the device. In one embodiment, when installing a selected operating system, the controller 520 and/or the embedded application 510 can access an image file and/or any executable files of a selected operating system from a corresponding storage device and use the contents of the image file and/or the executable files to install the selected operating system onto the device.

FIG. 5B illustrates a block diagram of an embedded application 510 generating a user interface 565 in response to a user selecting an operating system family according to an embodiment. This feature can be utilized if a user of a device would like to filter out certain operating systems of the same operating system family from being listed and selected from the user interface 565.

In one embodiment, an operating system family can include one or more operating systems which are each developed by the same developer or entity, such as Microsoft, Apple, and/or Sun. In another embodiment, operating systems included in the same operating system family can be compatible with a same or a similar kernel of the device, such as Linux, Unix, Microsoft Windows, and/or MAC OS.

In one embodiment, the controller 520 and/or the embedded application 510 can prompt the user to select an operating system family in response to the user interface 565 listing one or more compatible operating systems. In another embodiment, the controller 520 and/or the embedded application 510 can prompt the user to select an operating system family before the user interface 565 is generated to include one or more compatible operating systems.

The user can access the input device 570 to select one or more operating system families. As shown in FIG. 5B, the input device 570 has detected the user selecting operating system family 2. The controller 520 and/or the embedded application 510 can then attempt to identify compatible operating systems included in operating system family 2 by accessing the operating system database 590.

In one embodiment, as illustrated in FIG. 5B, each of the entries of the operating system database 590 can list an operating system family which the corresponding operating system is part of. As shown in FIG. 5, Operating System 1, Operating System 5, and Operating System 6 are included in Operating System Family 1. Additionally, Operating System 2 and Operating System 4 are included in Operating System Family 2. Further, Operating System 3 is included in Operating System Family 3.

As shown in FIG. 5B, the controller 520 and/or the embedded application 510 determine that Operating System 1, Operating System 4, and Operating System 6 are compatible operating systems. Further, of the compatible operating systems, Operating System 4 is included in Operating System Family 2. As a result, the controller 520 and/or the embedded application 510 generate the user interface 565 to list Operating System 4 as a compatible operating system which can be selected to be installed onto the device.

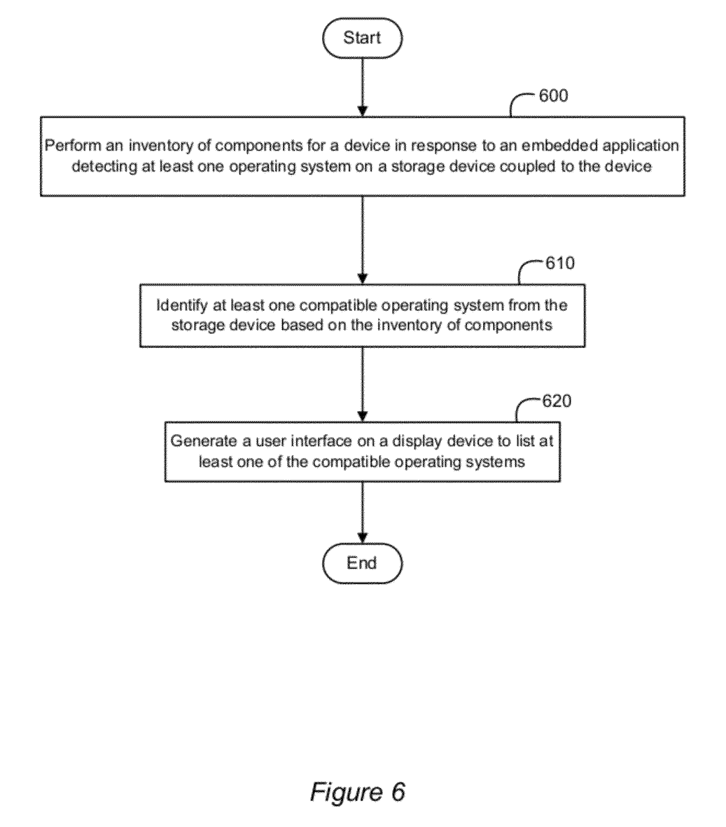

FIG. 6 is a flow chart illustrating a method for identifying a compatible operating system according to an embodiment. The method of FIG. 6 uses a device with a controller, a display device, one or more components of the device, one or more storage devices coupled to the device, a communication channel, and/or an embedded application. In other embodiments, the method of FIG. 6 uses additional components and/or devices in addition to and/or in lieu of those noted above and illustrated in FIGS. 1, 2, 3, 4, and 5.

As noted above, the embedded application is an application which can be used in conjunction with the controller to identify one or more compatible operating systems. In one embodiment, the embedded application can be BIOS or an embedded operating system of the device. A compatible operating system includes an operating system which includes or supports component drivers for each component of the device.

A component driver can be firmware and/or software utilized by the controller, the embedded application, and/or an operating system to control and/or communicate with a corresponding component of the device. A component can include a display device, a video component, an audio component, an input device, a network interface component, and/or any additional device or component coupled to the device.

The controller and/or the embedded application can initially perform an inventory of components for the device in response to detecting at least one operating system on a storage device coupled to the device 600. A storage device can be a device or component configured to store data and/or information, such as an operating system. Additionally, one or more storage devices can be included in the device or coupled to the device through an interface component of the device. In one embodiment, the interface component includes a network interface component.

As noted above, when performing the inventory of components, the controller and/or the embedded application can access each of the components included in and/or coupled to the device and read each components identification number. An identification number includes a sequence of numbers, letters, characters, and/or symbols unique to a component. Once the inventory of components has been performed, the controller and/or the embedded application can proceed to identify at least one compatible operating system based on the inventory of components 610.

The controller and/or the embedded application can access an operating system database and scan each entry for the matching identification numbers. As noted above, each entry corresponds to a different operating system. If any entries include matching identification numbers, the controller and/or the embedded application will determine that the corresponding operating system includes or supports component drivers for the components of the device. In response, controller and/or the embedded application will identify the operating systems as compatible operating systems.

The controller and/or the embedded application will then determine whether the compatible operating systems are included on storage devices coupled to the device. If any of the compatible operating systems are detected, the controller and/or the embedded application will proceed to generate a user interface on a display device to list at least one of the compatible operating systems 620. As noted above, the display device can be a digital or analog output device configured to render a user interface. The user interface can include one or more texts, images, menus, and/or graphics listing one or more of the compatible operating systems detected on the coupled storage devices. The method is then complete. In other embodiments, the method of FIG. 6 includes additional steps in addition to and/or in lieu of those depicted in FIG. 6.

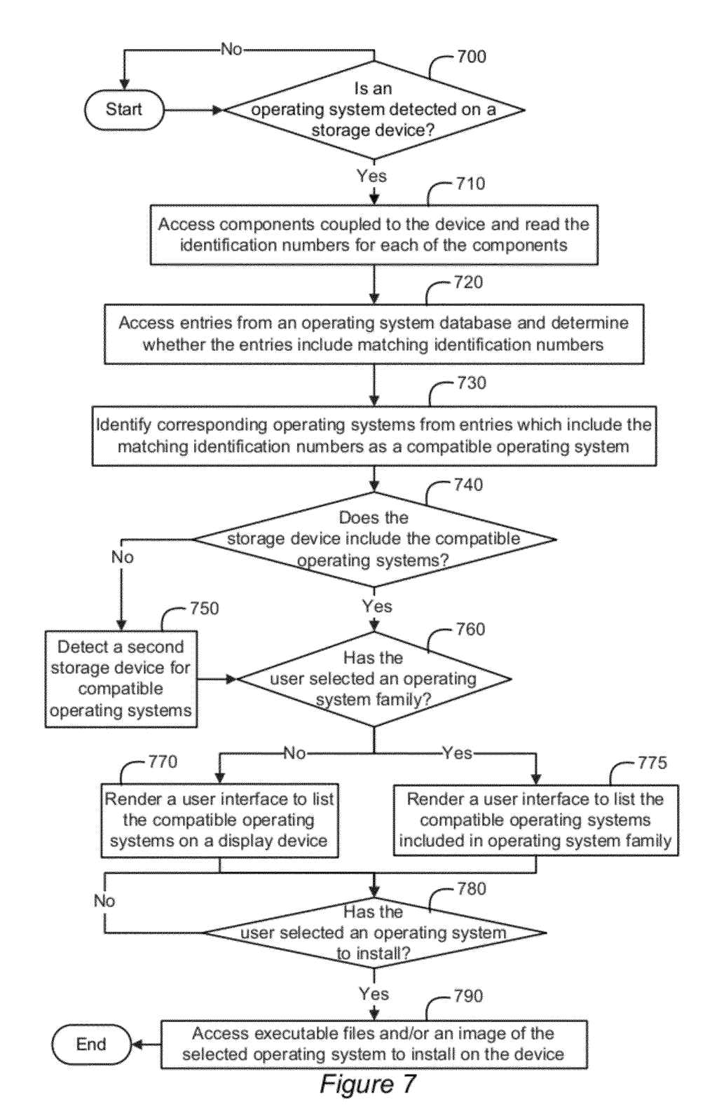

FIG. 7 is a flow chart illustrating a method for identifying a compatible operating system according to another embodiment. Similar to above, the method of FIG. 7 uses a device with a controller, a display device, one or more components of the device, one or more storage devices coupled to the device, a communication channel, and/or an embedded application. In other embodiments, the method of FIG. 7 uses additional components and/or devices in addition to and/or in lieu of those noted above and illustrated in FIGS. 1, 2, 3, 4, and 5.

As noted above, the controller and/or the embedded application can initially determine whether an operating system is detected on one or more storage devices coupled to the device 700. In one embodiment, the controller and/or the embedded application can access an interface component and detect one or more storage devices coupled to the device. If no storage devices are detected, the controller and/or the embedded application can continue detect for any storage devices coupled to the device.

In response to detecting a storage device coupled to the device, the controller and/or the embedded application can determine whether the information and/or data included in the coupled storage device includes one or more operating systems. If any operating systems are detected, the controller and/or the embedded application can proceed to access components included and/or coupled to the device and read identification numbers for each of the components 710. As noted above, the identification numbers can be stored in a PCB of a corresponding component or the identification numbers can be stored in a file, header, and/or metadata of the corresponding component.

Once all of the identification numbers have been read, the controller and/or the embedded application can proceed to access entries from an operating system database and determine whether any of the entries include matching identification numbers 720. The operating system database can be included in the device or controller and/or the embedded application can remotely access the operating system database from another location through a network interface component.

If any matches are found, the controller and/or the embedded application can identify the corresponding operating systems from entries which match the identification numbers as compatible operating systems 730. The controller and/or the embedded application can then proceed to access the storage devices coupled to the device and determine if they include the compatible operating systems 740. In one embodiment, the storage devices can be accessed concurrently and/or one by one.

If a storage device does not include any compatible operating system, the controller and/or the embedded application can proceed to detect a second or any additional coupled storage device for the compatible operating systems 750. The controller and/or the embedded application will then determine whether a user selected an operating system family 760. In another embodiment, if the first storage device included the compatible operating systems, the controller and/or the embedded application can skip step 750 and proceed to determine whether the user has selected an operating system family 760.

The user can be prompted through a display device to select one or more operating system families. An operating system family includes one or more operating systems which share the same developer. Additionally, the user can access an input device when selecting one or more operating system families. The input device can be a mouse, a keyboard, an image capture device, a microphone, a touch device and/or any additional device configured to detect the user selecting one or more operating system families.

If no operating system family is selected, the controller and/or the embedded application can proceed to generate a user interface to list all of the compatible operating systems found on the coupled storage device 770. The controller and/or the embedded application can then detect whether the user has selected one or more of the compatible operating systems to install 780.

In another embodiment, if the user did select an operating system family, the controller and/or the embedded application can access the operating system database to determine whether the compatible operating systems are included in the selected operating system family. The controller and/or the embedded application can then proceed to generate the user interface to list compatible operating systems from coupled storage devices which are included in the selected operating system family 775. The controller and/or the embedded application can then detect whether the user has selected one or more of the compatible operating systems to install 780.

The user can use the input device to select one or more compatible operating systems to install. If no operating system is detected, the controller and/or the embedded application can continue to detect for the user selecting a compatible operating system to install 780. In another embodiment, the controller and/or the embedded application can automatically select a compatible operating system to install. In other embodiments, if the user selects a compatible operating system, the controller and/or the embedded application can access the storage device storage the selected operating system and use an image and/or any executable files associated with the selected operating system to install the selected operating system onto the device 790. The method is then complete. In other embodiments, the method of FIG. 7 includes additional steps in addition to and/or in lieu of those depicted in FIG. 7.

What is claimed is:

1. A method for identifying a compatible operating system comprising:
performing an inventory of components for a device in response to an embedded application detecting at least one operating system on a storage device coupled to the device;
identifying at least one compatible operating system from the storage device based on the inventory of components; and
generating a user interface on a display device to list at least one of the compatible operating systems.

2. The method for identifying a compatible operating system of claim 1 wherein the embedded application performs the inventory of components in response to the device entering a boot phase.

3. The method for identifying a compatible operating system of claim 1 wherein performing the inventory of components includes reading identification numbers for each of the components.

4. The method for identifying a compatible operating system of claim 3 further comprising accessing entries in a database and determining whether the entries include the identification numbers of the components.

5. The method for identifying a compatible operating system of claim 4 further comprising identifying an operating system with a corresponding entry which matches the identification numbers as a compatible operating system.

6. The method for identifying a compatible operating system of claim 1 further comprising detecting a user selecting a compatible operating system from the user interface to install on the device.

7. The method for installing an operating system of claim 6 further comprising installing at least one of executable files and an image of the compatible operating system from the storage device.

8. A device comprising:
an embedded application executable by a controller from a computer readable memory to perform an inventory of components for the device in response to the embedded application detecting at least one operating system on a storage device coupled to the device;
wherein the controller identifies at least one compatible operating system from the storage device based on the inventory of components; and
a display device to render a user interface to include at least one of the compatible operating system.

9. The device of claim 8 further comprising an input device to detect a user of the device selecting a compatible operating system from the user interface to install onto the device.

10. The device of claim 8 wherein an operating system from the storage device is compatible with the device if the operating system includes component drivers for each of the components.

11. The device of claim 8 further comprising an operating system database accessible by the controller, wherein the operating system database includes entries for operating systems.

12. The device of claim 11 wherein each of the entries include a list of identification numbers for components which are compatible with the corresponding operating system.

13. The device of claim 11 further comprising a network interface component to update at least one entry in the operating system database.

14. The device of claim 8 wherein a component of the device can be at least one of included in the device and coupled to the device.

15. A computer readable medium comprising instructions that if executed cause a controller to:
perform an inventory of components for a device in response to an embedded application detecting at least one operating system on a storage device coupled to the device;
identify at least one compatible operating system from the storage device in response to the controller determining whether at least one of the operating systems on the storage device is compatible with the inventory of components; and
generate a user interface on a display device to list at least one of the compatible operating systems.

16. The computer readable medium comprising instructions of claim 15 wherein the controller compares identification numbers of the components to entries from an operating system database when determining whether a corresponding operating system listed in the operating system database is compatible with the device.

17. The computer readable medium comprising instructions of claim 16 wherein the controller determines whether a compatible operating system is included in the storage device.

18. The computer readable medium comprising instructions of claim 17 wherein the controller accesses a second storage device coupled to the device and determines whether the second storage device includes the compatible operating system if the compatible operating system is not detected on the storage device.

19. The computer readable medium comprising instructions of claim 15 wherein the display device prompts the user to select an operating system family and an input device detects the user selecting at least one family of operating system.

20. The computer readable medium comprising instructions of claim 15 wherein the controller further identifies at least one compatible operating system from the storage device based on the operating system family selected by the user.
